(19) United States
(12) Patent Application Publication
(10) Pub. No.: US 2013/0269017 A1
(43) Pub. Date: Oct. 10, 2013

(54) CENTRALIZED SINGLE SIGN ON SERVICE FOR WEBSITES AND ONLINE SERVICES

(71) Applicant: Dipak Patil, Miraj (IN)

(72) Inventor: Dipak Patil, Miraj (IN)

(73) Assignee: SALESFORCE.COM, INC., San Francisco, CA (US)

(21) Appl. No.: 13/439,672

(22) Filed: Apr. 4, 2012

(51) Int. Cl. G06F 21/00

(52) U.S. Cl. 726/8

(57) ABSTRACT

A system and related operating methods for performing single sign-on across a plurality of different online resources is provided here. The system receives first user credentials for a user, the first user credentials associated with a first online resource. The user is logged into the first online resource, using the first user credentials. While the user remains logged into the online resource, second user credentials for the user are received, wherein the second user credentials are associated with a second online resource. After receiving the second user credentials, a bidirectional single sign-on service is configured for the user. The service enables the user to log into the second online resource using the first user credentials, and enables the user to log into the first online resource using the second user credentials.

### TECHNICAL FIELD

Embodiments of the subject matter described herein relate generally to computer systems, communication networks, and related authentication procedures. More particularly, embodiments of the subject matter relate to authentication and login procedures for users of websites.

### BACKGROUND

Many users of the Internet use web-based email applications, online services, social networking sites, and other websites that require login credentials. For example, many users maintain multiple email accounts with different providers, multiple social networking accounts, etc. A “power user” may have different user credentials for many different websites, and keeping track of the user credentials can be cumbersome and frustrating. Some existing websites may have partnership arrangements with other websites that allow multiple websites to share the same user credentials for purposes of logging in a user. However, individual websites have not yet deployed any form of true single sign-on (SSO) functionality that allows end users to effectively use different user credentials for different websites in a seamless and transparent manner.

Accordingly, it is desirable to have an efficient and effective methodology for providing SSO across multiple websites. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of a network-based system;

FIG. 2 is a schematic representation of an embodiment of a device suitable for use in a system such as that depicted in FIG. 1;

FIG. 3 is a flow chart that illustrates an exemplary embodiment of an SSO configuration process;

FIG. 4 depicts an exemplary embodiment of an SSO list that could be maintained by a server device;

FIG. 5 is a flow chart that illustrates an exemplary embodiment of an SSO process; and

FIG. 6 is a schematic representation of an exemplary embodiment of a multi-tenant application system.

### DETAILED DESCRIPTION

The exemplary embodiments presented here relate to a computer-implemented network-based system that supports SSO across a plurality of different online resources (e.g., online services, web pages, domains, and/or websites) that are otherwise unrelated. The SSO functionality can be provided by a third party server-based system that manages the SSO operations for the online resources. In certain embodiments, participating websites can subscribe to the SSO service that is managed by the third party system. Thereafter, end users of supported websites are given the opportunity to activate SSO across two or more websites. Notably, once the SSO functionality is activated between any two websites, the user need not enter both sets of user credentials to gain access to both websites. Rather, authentication into either website (by way of the user credentials for that particular website) will automatically sign the user into the other website.

In accordance with one exemplary embodiment, if the SSO feature has been configured, then a user can log into Website_A using a first set of user credentials (that are associated with Website_A only). In response to this login process, the SSO server will automatically log the user into Website_B using a second set of user credentials (that are associated with Website_B only). In other words, the SSO server utilizes the actual credentials that would otherwise be needed to sign the user independently into Website_B. Conversely, if the user initially logs into Website_B using the second set of user credentials, the SSO server will transparently log the user into Website_A using the first set of user credentials.

The use of a third party service is desirable to ensure security and trustworthiness. Any number of providers (websites) can subscribe to the service to offer the SSO feature to the respective end users. Alternatively, the individual providers and websites could agree to implement the SSO functionality and security features on their own.

As an example, assume that a person has a user ID “abc_yahoo” on the YAHOO website, and a different user ID “abc_gmail” on the GOOGLE website. Then, after the user logs into the YAHOO website as “abc_yahoo”, the YAHOO website will give the option to configure SSO with the GOOGLE website. The user can then decide to configure SSO in this manner by providing his GOOGLE website credentials (the user ID “abc_gmail” and corresponding GOOGLE website password) to the SSO management mechanism, which in turn ensures proper authentication.

Thereafter, if the user is already logged into the YAHOO website and then opens a GOOGLE website application such as the GMAIL email service, that user will already be logged into the GOOGLE website application. From the perspective of the GOOGLE website application, the user has logged in using his ordinary GOOGLE website credentials (rather than the YAHOO website credentials or some shared credentials).

This feature is particularly important for providers of cloud-based services. For example, this feature could be employed where a cloud-based service provides multiple applications to its users, or if a single person concurrently uses multiple usernames in connection with one cloud-based application. In this case the user need not provide different forms of authentication information after configuring the user-activated SSO function described here.

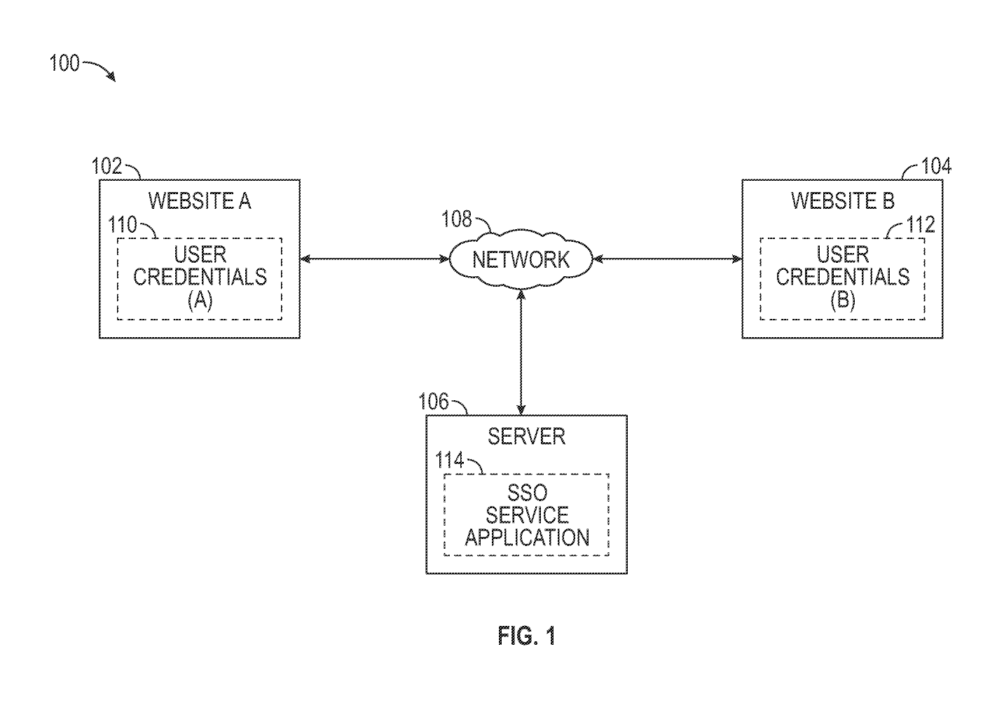

FIG. 1 is a schematic representation of a network-based computer-implemented system 100. The system 100 may be deployed using any number of server infrastructures, web servers, computer devices, or the like that are suitably configured to provide access to certain online resources. As used herein, “online resources” refers to any file, document, hosted application, online service (e.g., email), website, website domain, webpage, or item that can be accessed or retrieved via a network such as the Internet. The examples described here assume that the online resources are websites, web pages, or online services provided via websites or web pages, where the online resources require user credentials for access.

For this embodiment, the system 100 cooperates with the Internet and with a number of different websites or other online resources available via the Internet. The simplified depiction in FIG. 1 includes a first website 102 (Website “A”), a second website 104 (Website “B”), and an SSO server device 106, which communicate via a data communication network 108. The system 100 is preferably realized as a computer-implemented system in that the user devices (not shown) and the SSO server device 106 are configured as computer-based or processor-based electronic devices.

The websites 102, 104 can be hosted by one or more providers on any number of hardware platforms and devices. For this particular example, the website 102 is associated with a first domain (e.g., www.firstdomain.com) and the website 104 is associated with a second domain that is different than the first domain (e.g., www.seconddomain.com). Likewise, the SSO server device 106 could be maintained by one or more service providers using one or more hardware platforms.

For this example, a user has an account (e.g., an email account) with the first website 102. Accordingly, the first website 102 maintains or is otherwise associated with user credentials 110 for the user (User Credentials “A”). Thus, the user must enter his or her User Credentials “A” to sign into the first website 102 before gaining access to the email account. Similarly, the same user has an account (e.g., a social networking account) with the second website 104. Thus, the second website 104 maintains or is otherwise associated with user credentials 112 for the user (User Credentials “B”). The User Credentials “B” must be entered to gain access to the social networking account maintained at the second website 104. Notably, the user credentials 110 are different than the user credentials 112. Of course, the same user might have any number of different credentials for a variety of different websites (not shown) and/or for different services or resources available through any given website.

In practice, the websites 102, 104 can be accessed, used, and presented on any user device platform. In this regard, a user device (not shown) may be any computer-implemented device, such as, without limitation: a desktop computer, a mobile computer, a smartphone, a tablet computer, a video game device, a digital media player, or the like. In certain embodiments, the user device accesses the websites 102, 104 using a web browser application, as is well understood.

The SSO server device 106 represents the hardware, software, and processing logic that is suitably configured to perform the various SSO related functions, methods, and processes described here. In this regard, the SSO server device 106 may include an appropriate SSO service application 114 that, when executed, carries out the SSO functionality to support the websites 102, 104 (and any number of additional websites) and to support the users of the websites 102, 104 (and any number of additional users).

The data communication network 108 provides and supports data connectivity between the user devices (not shown), the SSO server device 106, and the web server devices that maintain and provide the websites 102, 104. In practice, the data communication network 108 may be any digital or other communications network capable of transmitting messages or data between devices, systems, or components. In certain embodiments, the data communication network 108 includes a packet switched network that facilitates packet-based data communication, addressing, and data routing. The packet switched network could be, for example, a wide area network, the Internet, or the like. In various embodiments, the data communication network 108 includes any number of public or private data connections, links or network connections supporting any number of communications protocols. The data communication network 108 may include the Internet, for example, or any other network based upon TCP/IP or other conventional protocols. In various embodiments, the data communication network 108 could also incorporate a wireless and/or wired telephone network, such as a cellular communications network for communicating with mobile phones, personal digital assistants, and/or the like. The data communication network 108 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol.

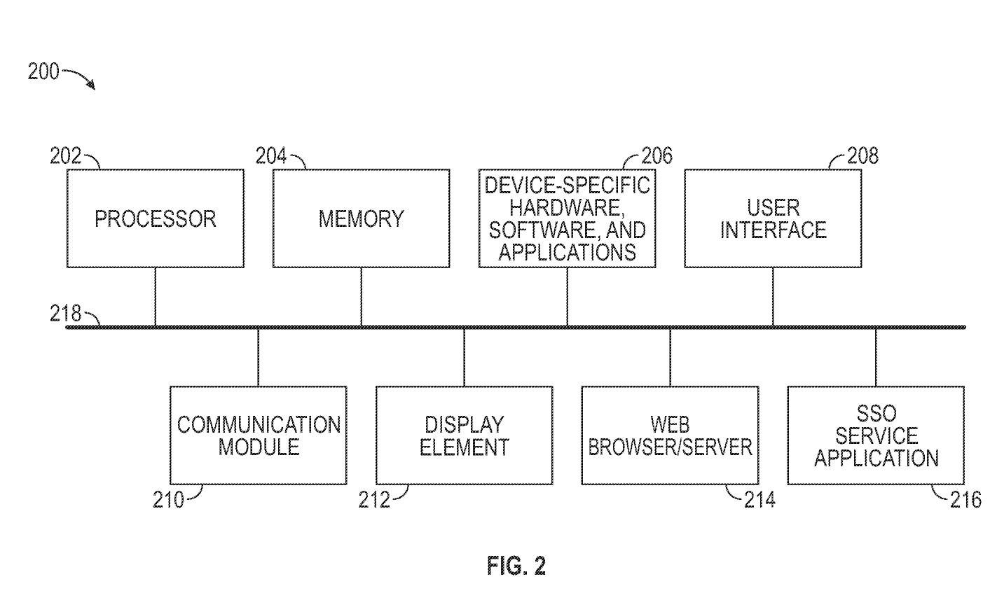

FIG. 2 is a schematic representation of an exemplary embodiment of an apparatus, system, or device 200 suitable for use in a system such as that depicted in FIG. 1. In practice, a web server device or the SSO server device 106 could be generally configured and implemented as shown in FIG. 2. Moreover, a client/user device could include most (if not all) of the elements, components, and functionality of the device 200. Accordingly, at least some of the following general description of the device 200 may be applicable to any of the main components of the system 100.

The illustrated embodiment of the device 200 includes, without limitation: at least one processor 202; a suitable amount of memory 204; device-specific hardware, software, firmware, and/or applications 206; a user interface 208; a communication module 210; a display element 212; a web browser/server 214; and an SSO service application 216. Of course, the device 200 may include additional elements, components, modules, and functionality configured to support various features that are unrelated to the subject matter described here. For example, the device 200 may include certain features and elements to support conventional functions that might be related to the particular implementation and deployment of the device 200. In practice, the elements of the device 200 may be coupled together via a bus or any suitable interconnection architecture 218.

The processor 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. A processor may be realized as a microprocessor, a controller, a microcontroller, or a state machine. Moreover, a processor may be implemented as a combination of computing devices, e.g., a combination of a digital signal processor and a microprocessor, a plurality of microprocessors, one or more microprocessors in conjunction with a digital signal processor core, or any other such configuration.

The memory 204 may be realized as RAM memory, flash memory, EPROM memory, EEPROM memory, registers, a hard disk, a removable disk, a CD-ROM, or any other form of storage medium known in the art. In this regard, the memory 204 can be coupled to the processor 202 such that the processor 202 can read information from, and write information to, the memory 204. In the alternative, the memory 204 may be integral to the processor 202. As an example, the processor 202 and the memory 204 may reside in an ASIC. The memory 204 can be used to store computer-readable media, where a tangible computer-readable medium has computer-executable instructions stored thereon (accordingly, the computer-readable medium is typically non-transitory in nature). The computer-executable instructions, when read and executed by the device 200, cause the device 200 to perform certain tasks, operations, functions, and processes described in more detail herein. In this regard, the memory 204 may represent one suitable implementation of such computer-readable media. Alternatively or additionally, the device 200 could receive and cooperate with computer-readable media (not separately shown) that is realized as a portable or mobile component or platform, e.g., a portable hard drive, a USB flash drive, an optical disc, or the like.

The device-specific hardware, software, firmware, and applications 206 may vary from one embodiment of the device 200 to another. For example, the device-specific hardware, software, firmware, and applications 206 will support telephone functions and features when the device 200 is realized as a mobile telephone, conventional personal computer functions and features if the device 200 is realized as a desktop or portable computer, and server functions and features if the device 200 is realized as a server device. In practice, certain portions or aspects of the device-specific hardware, software, firmware, and applications 206 may be implemented in one or more of the other blocks depicted in FIG. 2.

The user interface 208 may include or cooperate with various features to allow a user to interact with the device 200. Accordingly, the user interface 208 may include various human-to-machine interfaces, e.g., a keypad, keys, a keyboard, buttons, switches, knobs, a touchpad, a joystick, a pointing device, a virtual writing tablet, a touch screen, a microphone, or any device, component, or function that enables the user to select options, input information, or otherwise control the operation of the device 200. In various embodiments, the user interface 208 may include one or more graphical user interface (GUI) control elements that enable a user to manipulate or otherwise interact with an application via the display element 212. In this regard, the user interface 208 allows the user of a publisher device to interact with and manipulate context menus, dropdown menus, selectable radio buttons, sharing control elements, and other GUI features as needed.

The communication module 210 facilitates data communication between the device 200 and other components as needed during the operation of the device 200. In the context of this description, the communication module 210 can be employed during an online data communication session that includes the device 200 as one of the participant devices. Thus, the communication module 210 may be responsible for establishing and maintaining an Internet connection for a user device, and for establishing and maintaining a suitable data communication link between user devices and an SSO server device. An embodiment of the device 200 may support wireless data communication and/or wired data communication, using various data communication protocols. For example, the communication module 210 could support one or more wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. Moreover, the communication module 210 could support one or more wired/cabled data communication protocols, including, without limitation: Ethernet; home network communication protocols; USB; IEEE 1394 (Firewire); hospital network communication protocols; and proprietary data communication protocols.

The display element 212 is suitably configured to enable the device 200 to render and display various screens, GUIs, GUI control elements, drop down menus, auto-fill fields, text entry fields, message fields, or the like. Of course, the display element 212 may also be utilized for the display of other information during the operation of the device 200, as is well understood. Notably, the specific configuration, operating characteristics, size, resolution, and functionality of the display element 212 can vary depending upon the practical implementation of the device 200. For example, if the device 200 is a desktop computer, then the display element 212 may be a relatively large monitor. Alternatively, if the device 200 is a cellular telephone device, then the display element 212 may be a relatively small integrated display screen, which may be realized as a touch screen.

The web browser/server 214 may refer to hardware, software, firmware, and/or processing logic that supports web browser functionality for user devices and/or web server functionality for server devices. Web browser applications (e.g., the CHROME web browser application, the FIREFOX web browser application, or the SAFARI web browser application) and their functionality are well known and, therefore, will not be described in detail here. A web browser application can be used to retrieve and display online resources (e.g., web pages) at a user device. Web server applications and their functionality are well known and, therefore, will not be described in detail here. A web server application can be provided with a server device to enable the server device to deliver content (e.g., web pages) via the Internet.

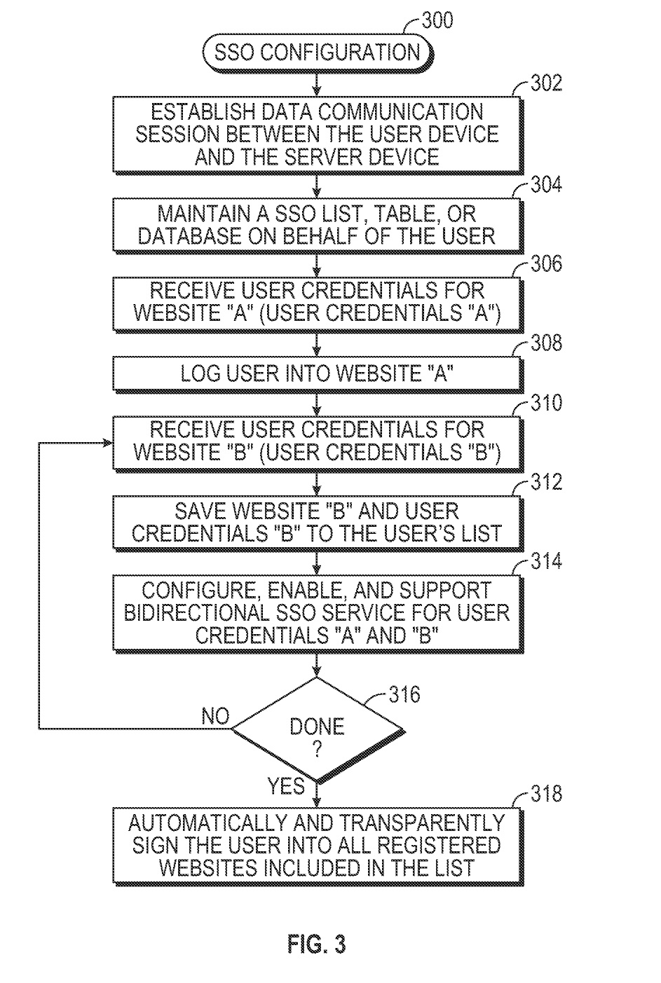

The SSO service application 216 can be utilized to provide the various SSO features and functions described here. In this regard, the SSO service application 216 resides at the SSO server device 106 shown in FIG. 1. Generally, the SSO service application 216 is responsible for configuring and maintaining the SSO functionality on behalf of one or more users of the system described here. Thus, the SSO service application 216 can be involved with an SSO configuration routine that allows a user to designate which (if any) online resources are to be registered for purposes of SSO. Moreover, the SSO service application 216 may be responsible for performing user authentication, sign-in, and/or log-in in an automated and transparent manner after SSO has been configured for a user. These and other SSO related features and functions are described in more detail below with reference to FIGS. 3-5.

FIG. 3 is a flow chart that illustrates an exemplary embodiment of an SSO configuration process 300. The various tasks performed in connection with any process described here (including the process 300) may be performed by software, hardware, firmware, or any combination thereof For illustrative purposes, the description of an illustrated process may refer to elements mentioned above in connection with FIG. 1 and FIG. 2. In practice, portions of a process may be performed by different elements of the described system, e.g., a server device, a user device, an application resident at a device, or the like. It should also be appreciated that a described process may include any number of additional or alternative tasks, the tasks shown in the figures need not be performed in the illustrated order, and a described process may be incorporated into a more comprehensive procedure or process having additional functionality not described in detail herein. Moreover, one or more of the tasks shown in the figures could be omitted as long as the intended overall functionality remains intact.

The illustrated embodiment of the process 300 begins by initiating and establishing a data communication session between a user device and a server device (task 302). In practice, task 302 may be associated with the launching of a web browser application at the user device, wherein an online session is created and maintained while the web browser remains open. In certain embodiments, a session identifier or session token may be assigned to the data communication session established during task 302. The process 300 may also create and maintain an SSO list, table, or database on behalf of the user (task 304). As described in more detail below, the SSO list includes a list of registered or configured online resources, along with their corresponding user credentials that are needed to log into, sign onto, or otherwise gain access to the registered online resources. The list of user credentials maintained in the list can be used to support the bidirectional SSO service for the user.

While the data communication session remains active, the process 300 receives user credentials for the user (task 306). This example assumes that the user has signed into a first website (e.g., Website “A”) using his or her credentials that are associated with that particular website (e.g., User Credentials “A”). Accordingly, the process 300 uses the received user credentials to authenticate the user and log the user into the first website (task 308). Once successfully logged into the first website for access, the user may be presented with the option to configure or setup the cross-website SSO feature. For example, the user could navigate to an “Options” page or a “Settings” page. Alternatively, the home page of the first website could display a reminder or an icon that prompts the user to set up the SSO functionality.

This example assumes that the user decides to configure SSO for at least a second website, Website “B”. Although not always required, this example assumes that Website “A” is associated with a first domain, and that Website “B” is associated with a second domain that is different than the first domain. At this point, the user could be presented with the option to configure SSO for any number of candidate websites, assuming that those websites have subscribed to the SSO service with the third party provider. This option is presented while the user remains logged into the first website, and during the same data communication session. This simple example assumes that the user selects only the Website “B” for purposes of SSO setup. Accordingly, the process 300 receives the user credentials for Website “B” (task 310). The user credentials for Website “B” (referred to here as User Credentials “B”) may be different than the user credentials for Website “A”. In this regard, the user may be asked to securely enter the username and password for access to Website “B”, and this information is sent to the SSO server device for saving and maintaining For this particular embodiment, the process 300 saves data that identifies Website “B”, along with the corresponding User Credentials “B” to the SSO list maintained for the user (task 312).

The process 300 may continue by configuring, enabling, and supporting a bidirectional SSO service for the user (task 314). At this point, the SSO service is applicable to at least User Credentials “A” and User Credentials “B”. Thus, the bidirectional SSO service enables the user to log into Website “B” using the User Credentials “A”, and enables the user to log into Website “A” using the User Credentials “B”. In practice, therefore, if the user logs into either Website “A” or Website “B” using the corresponding user credentials, the SSO service will automatically log the user into the other website in a transparent manner.

If the configuration procedure is done (the “Yes” branch of query task 316), then the process 300 may continue by automatically and transparently signing the user into all of the currently registered websites included in the list (task 318). This seamless SSO process allows the user to be logged into any number of online resources automatically as long as he or she provides user credentials for any one of the registered online resources on the list. If the configuration procedure is not finished (the “No” branch of query task 316), then the process 300 may return to task 310 for purposes of receiving and processing user credentials for another website to be added to the registered list.

Upon completion of the process 300, the data communication session can be terminated and the user can exit the web browser. The SSO configuration is preserved by the SSO server device, however, to accommodate subsequent online sessions for the user. In this regard, the SSO list may be accessed and consulted during subsequent online sessions as needed to provide the bidirectional SSO service for the user.

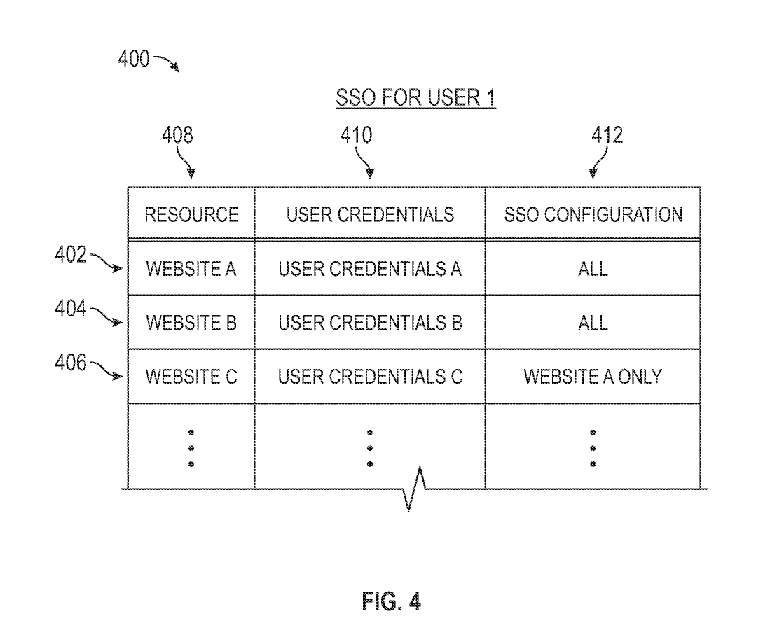

FIG. 4 depicts an exemplary embodiment of an SSO list 400 that could be maintained by a server device. The SSO list 400 is applicable to one user, namely, User 1. In practice, the server device could maintain an SSO list for each user, or a combined list that includes entries for a plurality of users. The SSO list 400 may include any number of entries for any number of registered online resources. This example includes only three specific entries for the sake of brevity and simplicity. A first entry 402 is for the Website “A”, a second entry 404 is for the Website “B”, and a third entry 406 is for the Website “C”. The first column 408 of the SSO list 400 identifies or indicates the respective online resource in an appropriate format, e.g., a uniform resource locator, a network address, or the like. The second column 410 of the SSO list 400 identifies or indicates the respective user credentials for that particular online resource. In practice, the user credentials may include at least a username and a password, as is well understood. Of course, the user credentials may include more or less information, depending upon the particular embodiment. The third column 412 of the SSO list 400 identifies or indicates the respective SSO configuration to be applied to that particular online resource. For example, the entry 402 for the Website “A” has an SSO configuration designated by “ALL”. In accordance with this designation, if the User Credentials “A” are entered, then the SSO service will attempt to seamlessly log the user onto all of the other websites included in the list. The same SSO action is configured for the entry 404 for the Website “B”. In contrast, however, the entry 406 for the Website “B” has a selective SSO configuration, namely, “WEBSITE A ONLY”. In accordance with this designation, if the User Credentials “C” are entered, then the SSO service will attempt to seamlessly log the user onto Website “A” only, and no other websites will be automatically signed into. Although not shown in FIG. 4, the SSO configuration could provide any type of selectivity, and the SSO configuration could be as simple or as complex as desired. For instance, the SSO configuration could be arranged such that SSO is performed for a specified number of websites, and such that SSO is not performed for a specified number of other websites. As another example, the SSO configuration could be arranged such that SSO is performed only for websites that share a common domain. For the exemplary embodiment described here, the default SSO configuration is “ALL”—this default SSO configuration achieves bidirectional SSO capability across all registered websites included in the SSO list 400.

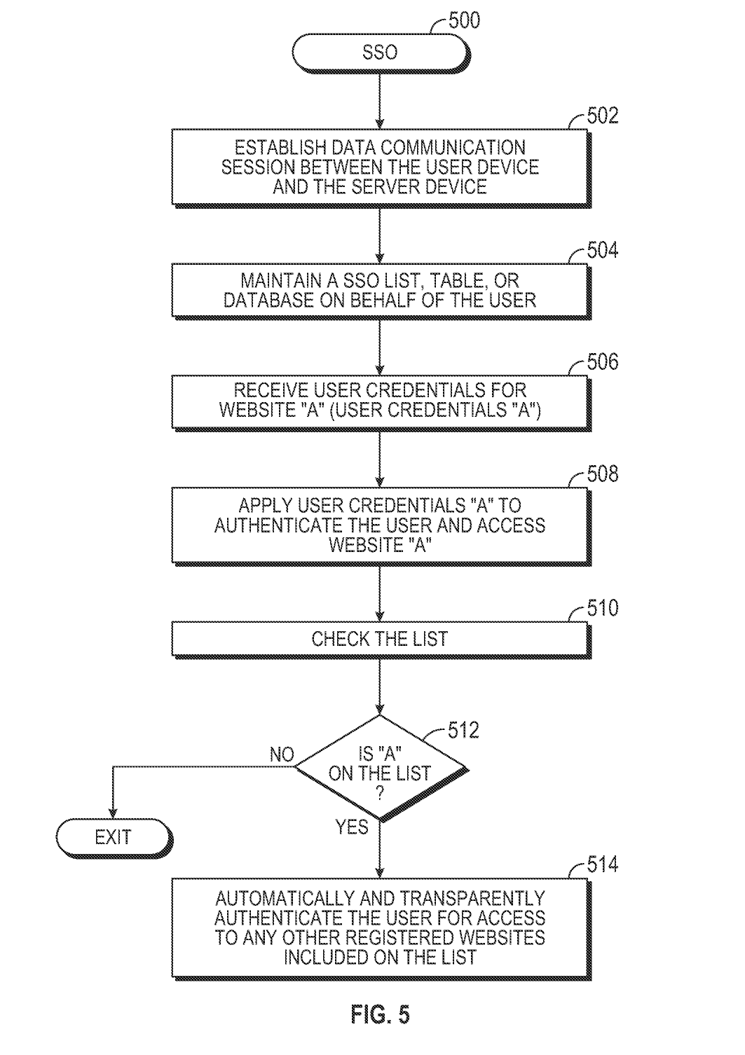

FIG. 5 is a flow chart that illustrates an exemplary embodiment of an SSO process 500, which may be performed after the SSO feature has been configured for at least two different websites. Thus, the process 500 may be performed in conjunction with the SSO configuration process 300 described above. Although not always the case, the following example assumes that the user configured the SSO service for at least two different websites during an online session, and thereafter terminated the session or otherwise logged out of the websites. Accordingly, the illustrated embodiment of the process 500 begins by initiating and establishing a data communication session between the user device and a server device (task 502). In practice, task 502 may be associated with the launching of a web browser application at the user device, wherein an online session is created and maintained while the web browser remains open. In certain embodiments, a session identifier or session token may be assigned to the data communication session established during task 502.

The process 500 may also maintain and access the SSO list, table, or database on behalf of the user (task 504), as described above. While the data communication session remains active and ongoing, the process 500 receives User Credentials “A” from the user device (task 506). The process 500 applies the received User Credentials “A” to authenticate the user, access Website “A”, and log the user into Website “A” using any suitable authentication technique (task 508). Notably, task 508 represents an initial or first login for the user in that the SSO service has not yet been invoked to automatically log the user into any other websites. In other words, this example assumes that the user has not previously logged into any other registered websites included in the SSO list during the current data communication session.

The illustrated embodiment of the process 500 checks the SSO list for the user to determine whether or not the SSO list includes an entry for Website “A” and/or for User Credentials “A” (task 510). In other words, task 510 checks whether or not Website “A” is a registered website for purposes of the SSO service. If an entry for Website “A” and/or for User Credentials “A” does not exist (the “No” branch of query task 512), then the process 500 may exit and simply allow the user to remain logged into Website “A” in accordance with conventional operating principles. If an entry for Website “A” and/or for User Credentials “A” exists (the “Yes” branch of query task 512), then the process 500 continues by automatically, seamlessly, and transparently authenticating the user for access to at least one additional website having an entry in the SSO list (task 514). In certain embodiments, task 514 automatically logs the user into all registered websites, subject to any restrictions or limitations defined by the user-entered SSO configuration data. In practice, the SSO server may perform task 514 by accessing the SSO list, obtaining additional user credentials from the SSO list, and applying those user credentials in the background in a manner that is transparent to the user. The additional user credentials correspond to other registered online resources (e.g., websites) that have been previously configured for purposes of the SSO service.

The example provided here assumes that the user initially logs into Website “A” with User Credentials “A”. It should be appreciated, however, that the process 500 can be performed in an equivalent manner for any initial online resource, whether or not the initial online resource appears on the SSO list. As mentioned above (see query task 512), if the initial website does not appear on the SSO list, then SSO does not apply. However, if the initial website appears on the SSO list, then the SSO functionality can be invoked. Thus, if Website “A”, Website “B”, and Website “C” are included in the SSO list, the user can log into any of those three websites as the “initial website” to invoke the seamless SSO service and, consequently, log into all three websites without any further user input or involvement.

In an alternative embodiment, the process 500 could delay the authentication performed during task 508 (i.e., logging the user into the initial website) and instead perform the authentication for the initial website during task 514. Thus, the user could be automatically logged into the initial website concurrently with any registered websites that are included in the SSO list.

In practice, the SSO server device may preserve the authenticated status of the user throughout the current online session. Thus, if the user closes the current browser session, it may be necessary to again enter one set of credentials to gain SSO access to the registered websites. Moreover, the SSO server device may preserve the authenticated status of the user without actually providing all of the registered website content to the user device. For example, if the initial website is Website “A”, the user may open another browser window to access Website “B” (without having to enter User Credentials “B”), open a new tab in the existing browser window to access Website “C” (without having to enter User Credentials “C”), navigate away from Website “A” to Website “B” (without having to enter User Credentials “B”), or the like. This action involves the SSO service, which provides the user credentials for purposes of logging the user into the different registered websites.

It should be appreciated that once configured, the SSO functionality will be bi-directional in nature, regardless of which website was used to configure the SSO feature. Thus, if the user in the above example closes all web browsers (after configuring the SSO service), ends all current sessions, and thereafter re-launches a browser to access Website “B” directly, the SSO capability will function in the reverse direction. In other words, the user can enter the credentials for Website “B”, gain access to Website “B”, and then navigate to Website “A” (while in the same session) seamlessly without having to enter the credentials for Website “A”. Once configured in the manner described above, the SSO server will manage and handle SSO authentication procedures for any user of a website that has subscribed to the SSO service provided by the SSO server.

The exemplary embodiments presented here relate to various computer-implemented and computer-executed techniques related to user authentication and SSO. The described subject matter could be implemented in connection with any suitable computer-based architecture, system, network, or environment, such as two or more user devices that communicate via a data communication network. Although the subject matter presented here could be utilized in connection with any type of computing environment, certain exemplary embodiments can be implemented in conjunction with a multi-tenant database environment.

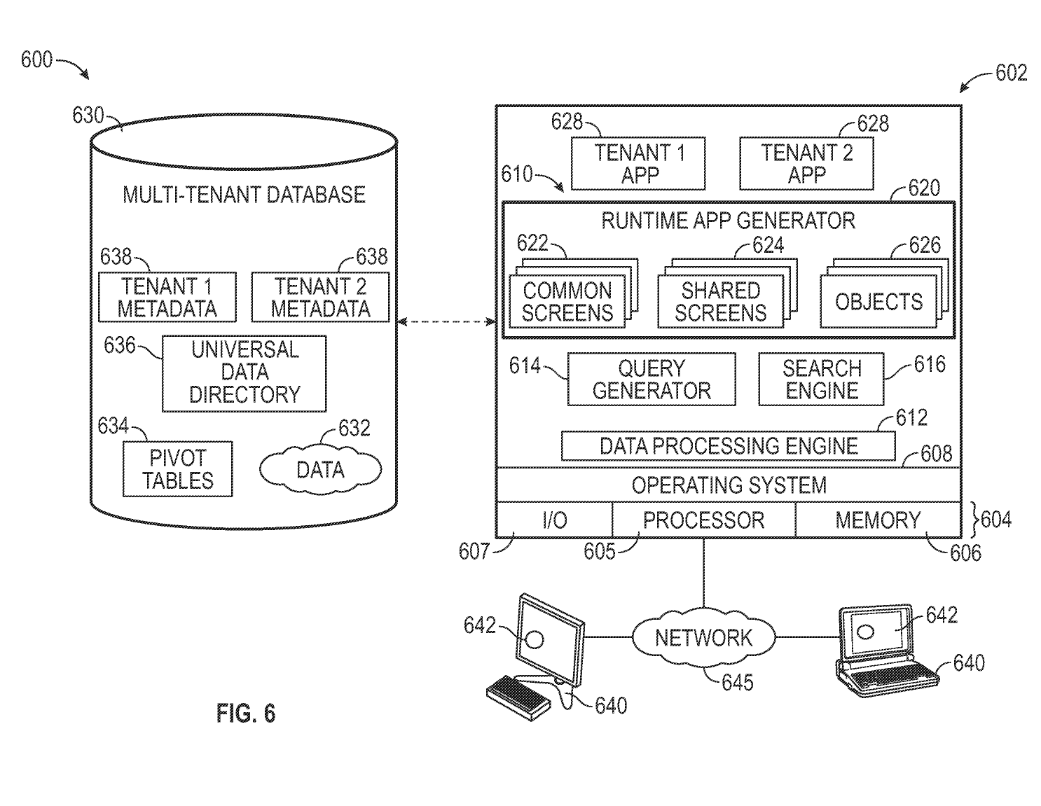

In this regard, an exemplary embodiment of a multi-tenant application system 600 is shown in FIG. 6. The system 600 suitably includes a server 602 that dynamically creates virtual applications 628 based upon data 632 from a common database 630 that is shared between multiple tenants. Data and services generated by the virtual applications 628 are provided via a network 645 to any number of user devices 640, as desired. Each virtual application 628 is suitably generated at run-time using a common application platform 610 that securely provides access to the data 632 in the database 630 for each of the various tenants subscribing to the system 600. In accordance with one non-limiting example, the system 600 may be implemented in the form of a multi-tenant CRM system that can support any number of authenticated users of multiple tenants.

A “tenant” or an “organization” generally refers to a group of users that shares access to common data within the database 630. Tenants may represent customers, customer departments, business or legal organizations, and/or any other entities that maintain data for particular sets of users within the system 600. Although multiple tenants may share access to the server 602 and the database 630, the particular data and services provided from the server 602 to each tenant can be securely isolated from those provided to other tenants. The multi-tenant architecture therefore allows different sets of users to share functionality without necessarily sharing any of the data 632.

The database 630 is any sort of repository or other data storage system capable of storing and managing the data 632 associated with any number of tenants. The database 630 may be implemented using any type of conventional database server hardware. In various embodiments, the database 630 shares processing hardware 604 with the server 602. In other embodiments, the database 630 is implemented using separate physical and/or virtual database server hardware that communicates with the server 602 to perform the various functions described herein.

The data 632 may be organized and formatted in any manner to support the application platform 610. In various embodiments, the data 632 is suitably organized into a relatively small number of large data tables to maintain a semi-amorphous “heap”-type format. The data 632 can then be organized as needed for a particular virtual application 628. In various embodiments, conventional data relationships are established using any number of pivot tables 634 that establish indexing, uniqueness, relationships between entities, and/or other aspects of conventional database organization as desired.

Further data manipulation and report formatting is generally performed at run-time using a variety of metadata constructs. Metadata within a universal data directory (UDD) 636, for example, can be used to describe any number of forms, reports, workflows, user access privileges, business logic and other constructs that are common to multiple tenants. Tenant-specific formatting, functions and other constructs may be maintained as tenant-specific metadata 638 for each tenant, as desired. Rather than forcing the data 632 into an inflexible global structure that is common to all tenants and applications, the database 630 is organized to be relatively amorphous, with the pivot tables 634 and the metadata 638 providing additional structure on an as-needed basis. To that end, the application platform 610 suitably uses the pivot tables 634 and/or the metadata 638 to generate “virtual” components of the virtual applications 628 to logically obtain, process, and present the relatively amorphous data 632 from the database 630.

The server 602 is implemented using one or more actual and/or virtual computing systems that collectively provide the dynamic application platform 610 for generating the virtual applications 628. The server 602 operates with any sort of conventional processing hardware 604, such as a processor 605, memory 606, input/output features 607 and the like. The processor 605 may be implemented using one or more of microprocessors, microcontrollers, processing cores and/or other computing resources spread across any number of distributed or integrated systems, including any number of “cloud-based” or other virtual systems. The memory 606 represents any non-transitory short or long term storage capable of storing programming instructions for execution on the processor 605, including any sort of random access memory (RAM), read only memory (ROM), flash memory, magnetic or optical mass storage, and/or the like. The server 602 typically includes or cooperates with some type of computer-readable media, where a tangible computer-readable medium has computer-executable instructions stored thereon. In this regard, the memory 606 may represent one suitable implementation of such computer-readable media. The computer-executable instructions, when read and executed by the server 602, cause the server 602 to perform certain tasks, operations, functions, and processes described in more detail herein. Notably, the processor 605 and the memory 606 may be suitably configured to carry out the various SSO configuration and operating features described above. In other words, the server 602 may include some or all of the functionality of the SSO server device described above.

The input/output features 607 represent conventional interfaces to networks (e.g., to the network 645, or any other local area, wide area or other network), mass storage, display devices, data entry devices and/or the like. In a typical embodiment, the application platform 610 gains access to processing resources, communications interfaces and other features of the processing hardware 604 using any sort of conventional or proprietary operating system 608. As noted above, the server 602 may be implemented using a cluster of actual and/or virtual servers operating in conjunction with each other, typically in association with conventional network communications, cluster management, load balancing and other features as appropriate.

The application platform 610 is any sort of software application or other data processing engine that generates the virtual applications 628 that provide data and/or services to the user devices 640. The virtual applications 628 are typically generated at run-time in response to queries received from the user devices 640. For the illustrated embodiment, the application platform 610 includes a bulk data processing engine 612, a query generator 614, a search engine 616 that provides text indexing and other search functionality, and a runtime application generator 620. Each of these features may be implemented as a separate process or other module, and many equivalent embodiments could include different and/or additional features, components or other modules as desired.

The runtime application generator 620 dynamically builds and executes the virtual applications 628 in response to specific requests received from the user devices 640. The virtual applications 628 created by tenants are typically constructed in accordance with the tenant-specific metadata 638, which describes the particular tables, reports, interfaces and/or other features of the particular application. In various embodiments, each virtual application 628 generates dynamic web content (including GUIs, detail views, secondary or sidebar views, and the like) that can be served to a browser or other client program 642 associated with its user device 640, as appropriate.

The runtime application generator 620 suitably interacts with the query generator 614 to efficiently obtain multi-tenant data 632 from the database 630 as needed. In a typical embodiment, the query generator 614 considers the identity of the user requesting a particular function, and then builds and executes queries to the database 630 using system-wide metadata 636, tenant specific metadata 638, pivot tables 634, and/or any other available resources. The query generator 614 in this example therefore maintains security of the common database 630 by ensuring that queries are consistent with access privileges granted to the user that initiated the request.

The data processing engine 612 performs bulk processing operations on the data 632 such as uploads or downloads, updates, online transaction processing, and/or the like. In many embodiments, less urgent bulk processing of the data 632 can be scheduled to occur as processing resources become available, thereby giving priority to more urgent data processing by the query generator 614, the search engine 616, the virtual applications 628, etc. In certain embodiments, the data processing engine 612 and the processor 605 cooperate in an appropriate manner to perform and manage various techniques, processes, and methods associated with SSO, as described previously with reference to FIGS. 1-5.

In operation, developers use the application platform 610 to create data-driven virtual applications 628 for the tenants that they support. Such virtual applications 628 may make use of interface features such as tenant-specific screens 624, universal screens 622 or the like. Any number of tenant-specific and/or universal objects 626 may also be available for integration into tenant-developed virtual applications 628. The data 632 associated with each virtual application 628 is provided to the database 630, as appropriate, and stored until it is requested or is otherwise needed, along with the metadata 638 that describes the particular features (e.g., reports, tables, functions, etc.) of that particular tenant-specific virtual application 628. For example, a virtual application 628 may include a number of objects 626 accessible to a tenant, wherein for each object 626 accessible to the tenant, information pertaining to its object type along with values for various fields associated with that respective object type are maintained as metadata 638 in the database 630. In this regard, the object type defines the structure (e.g., the formatting, functions and other constructs) of each respective object 626 and the various fields associated therewith. In an exemplary embodiment, each object type includes one or more fields for indicating the relationship of a respective object of that object type to one or more objects of a different object type (e.g., master-detail, lookup relationships, or the like).

In exemplary embodiments, the application platform 610, the data processing engine 612, the query generator 614, and the processor 605 cooperate in an appropriate manner to process data associated with a hosted virtual application 628 (such as a CRM application), generate and provide suitable GUIs (such as web pages) for presenting data on client devices 640, and perform additional techniques, processes, and methods to support the features and functions related to SSO configuration and SSO servicing for the hosted virtual application 628.

Still referring to FIG. 6, the data and services provided by the server 602 can be retrieved using any sort of personal computer, mobile telephone, portable device, tablet computer, or other network-enabled user device 640 that communicates via the network 645. Typically, the user operates a conventional browser or other client program 642 to contact the server 602 via the network 645 using, for example, the hypertext transport protocol (HTTP) or the like. The user typically authenticates his or her identity to the server 602 to obtain a session identifier (“SessionID”) that identifies the user in subsequent communications with the server 602. When the identified user requests access to a virtual application 628, the runtime application generator 620 suitably creates the application at run time based upon the metadata 638, as appropriate. The query generator 614 suitably obtains the requested data 632 from the database 630 as needed to populate the tables, reports or other features of the particular virtual application 628. As noted above, the virtual application 628 may contain Java, ActiveX, or other content that can be presented using conventional client software running on the user device 640; other embodiments may simply provide dynamic web or other content that can be presented and viewed by the user, as desired.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a tangible non-transitory processor-readable medium in certain embodiments. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, or the like.

While at least one exemplary embodiment has been presented in the foregoing detailed description, it should be appreciated that a vast number of variations exist. For example, although the above description assumes that the publisher device functions as the sharing device, the desktop sharing application could be designed to also allow a viewer device to share files/folders with another viewer device and/or with the publisher device, using the existing data communication connections. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for performing single sign-on across a plurality of different online resources, the method comprising:
receiving first user credentials for a user, wherein the first user credentials are associated with a first online resource;
logging the user into the first online resource, using the first user credentials;
while the user remains logged into the online resource, receiving second user credentials for the user, wherein the second user credentials are associated with a second online resource, and wherein the second user credentials are different than the first user credentials; and
after receiving the second user credentials, configuring a bidirectional single sign-on service for the user, wherein the bidirectional single sign-on service enables the user to log into the second online resource using the first user credentials, and enables the user to log into the first online resource using the second user credentials.

2. The method of claim 1, further comprising establishing a data communication session between a user device and a server device, wherein receiving the first user credentials and receiving the second user credentials are performed by the server device during the data communication session.

3. The method of claim 2, wherein configuring the bidirectional single sign-on service is performed by the server device.

4. The method of claim 1, further comprising:
after configuring the bidirectional single sign-on service, logging the user out of the first online resource;
thereafter, obtaining the first user credentials; and
in response to obtaining the first user credentials, automatically and seamlessly logging the user into both the first online resource and the second online resource using the single sign-on service in a manner that is transparent to the user.

5. The method of claim 1, further comprising:
after configuring the bidirectional single sign-on service, logging the user out of the first online resource;
thereafter, obtaining the second user credentials; and
in response to obtaining the second user credentials, automatically and seamlessly logging the user into both the first online resource and the second online resource using the single sign-on service in a manner that is transparent to the user.

6. The method of claim 1, wherein:
the first online resource comprises at least one webpage associated with a first domain; and
the second online resource comprises at least one webpage associated with a second domain.

7. The method of claim 1, wherein:
the first online resource comprises at least one online service associated with a first domain; and
the second online resource comprises at least one online service associated with a second domain.

8. A server device comprising a processor and memory, wherein the memory comprises computer-executable instructions that, when executed by the processor, cause the server device to:
maintain a list on behalf of a user, the list including registered online resources and corresponding user credentials for a bidirectional single sign-on service;
receive first user credentials for a user;
authenticate the user for access to a first online resource, using the first user credentials;
check the list to determine whether an entry exists for the first online resource and the first user credentials; and
when an entry exists for the first online resource and the first user credentials, authenticating the user for access to at least one additional online resource having an entry in the list, using additional user credentials corresponding to the at least one additional online resource.

9. The server device of claim 8, wherein the computer-executable instructions, when executed by the processor, cause the server device to:
establish a data communication session with a user device;
log the user into the first online resource during the data communication session, using the first user credentials; and
log the user into the at least one additional online resource during the data communication session, using the additional user credentials.

10. The server device of claim 8, wherein:
the first online resource comprises at least one webpage associated with a first domain; and
the at least one additional online resource comprises at least one webpage associated with a second domain.

11. The server device of claim 8, wherein:
the first online resource comprises at least one online service associated with a first domain; and
the at least one additional online resource comprises at least one online service associated with a second domain.

12. The server device of claim 8, wherein the computer-executable instructions, when executed by the processor, cause the server device to:
configure the bidirectional single sign-on service for the user, wherein the bidirectional single sign-on service enables the user to log into any of the registered online resources contained in the list using any one of the corresponding user credentials contained in the list.

13. A method for performing single sign-on across a plurality of different online resources, the method comprising:
maintaining a list on behalf of a user, the list including registered online resources and corresponding user credentials for a bidirectional single sign-on service;
receiving first user credentials for a user, wherein the first user credentials are associated with a first online resource;
authenticating the user for access to the first online resource, using the first user credentials;
checking the list to determine whether an entry exists for the first online resource and the first user credentials; and
when an entry exists for the first online resource and the first user credentials, authenticating the user for access to a second online resource having an entry in the list, using second user credentials contained in the list, wherein the second user credentials are associated with the second online resource, and wherein the second user credentials are different than the first user credentials.

14. The method of claim 13, wherein authenticating the user for access to the second online resource is automatically performed in a manner that is transparent to the user.

15. The method of claim 13, wherein:
the first online resource comprises at least one webpage associated with a first domain; and
the second online resource comprises at least one webpage associated with a second domain.

16. The method of claim 13, wherein:
the first online resource comprises at least one online service associated with a first domain; and
the second online resource comprises at least one online service associated with a second domain.

17. The method of claim 13, wherein:
the list includes a plurality of registered online resources and a corresponding plurality of user credentials; and
when an entry exists for any one of the registered online resources and corresponding received user credentials, the method authenticates the user for access to the plurality of registered online resources, using the corresponding received user credentials and additional user credentials contained in the list.

18. The method of claim 13, further comprising configuring the bidirectional single sign-on service by:
obtaining, from a user device, respective user credentials for a plurality of different online resources;
identifying the plurality of different online resources as registered online resources;
saving the registered online resources and the corresponding user credentials in the list; and
enabling bidirectional single sign-on functionality for the registered online resources.

19. The method of claim 18, wherein the bidirectional single sign-on service enables the user to log into any of the registered online resources contained in the list using any one of the corresponding user credentials contained in the list.
